(19) United States
(12) Patent Application Publication
(10) Pub. No.: US 2009/0265165 A1
(43) Pub. Date: Oct. 22, 2009

(54) AUTOMATIC META-DATA TAGGING PICTURES AND VIDEO RECORDS

(75) Inventors: Johan APELQVIST, Hjarup (SE); Erik BACKLUND, Gantofta (SE); Henrik Bengtsson, Lund (SE); Mats LINDOFF, Lund (SE); Daniel LONNBLAD, Genarp (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/106,353

(22) Filed: Apr. 21, 2008

(51) Int. Cl. G10L 19/00

(52) U.S. Cl. 704/201; 704/E19.001

(57) ABSTRACT

A method and apparatus for labeling an image recorded by a portable electronic device with descriptive tags is disclosed. Sounds in the vicinity of the portable electronic device are recorded. When the image is captured, the audio record of recorded sounds from a first predetermined period of time prior to the capture of the image until a second predetermined period of time after the capture of the image is retrieved. The retrieved audio record is processed to create a list of recognizable words in the retrieved audio record. The list of recognizable words is then stored in a metatag field associated with the captured image.

### TECHNICAL FIELD OF THE INVENTION

The present invention relates to the storage of digital images and more particularly to a method and apparatus for labeling images with metatags.

### DESCRIPTION OF RELATED ART

Cameras and other image capturing devices have increasingly become smaller and are often present in portable electronic devices, like cellular phones. The available memory space of portable electronic devices has been increasing rapidly such that many captured images may be digitally stored in the portable electronic devices. In addition to still images, the portable electronic devices may also capture and store video streams.

With the increase in storage capacity, it is important to allow users to quickly access the pictures stored in the memory. However, the more pictures that are stored in the memory, the longer it will take the user to search through all of the images for the one image they are looking for. For example, if the portable electronic device has 250 images stored in a memory, the user will not want to search through all of the images to find the specific image they are looking for.

One way of categorizing the stored images is to use metatags for each picture. Metatags are words which describe one or more features of the image which are stored with the image in a searchable form. For example, the metatags “Beach” and “Vacation 2007” may be used to describe a picture of a beach taken on the user's vacation in 2007. While the use of metatags can create an effective manner for looking for selected pictures, the use of metatags has several drawbacks. Today, a user has to either manually create the metatags and/or use some automatic techniques like image recognition to find people or objects in an image or GPS equipment to set the location of the picture. This process can be very time consuming and/or expensive which discourages people from using metatags with their pictures.

Thus, there is a need for a method and apparatus for labeling an image with metatags in a user friendly and economical manner.

### SUMMARY OF THE INVENTION

According to some embodiments of the invention, a method for labeling an image recorded by a portable device with descriptive tags, comprising the steps of: recording sounds in the vicinity of the portable device; capturing the image; retrieving audio record of recorded sounds from a first predetermined period of time prior to the capture of the image until a second predetermined period of time after the capture of the image; processing the retrieved audio record to create a list of recognizable words in the retrieved audio record; and storing said list of recognizable words in a metatag field associated with the captured image.

According to another embodiment of the invention, a method for labeling an image recorded by a portable device, comprising the steps of: capturing the image; recording sounds in the vicinity of the portable device for a predetermined period of time after the image is captured; processing the recorded sounds to create a list of recognizable words in the recorded sounds; storing said list of recognizable words in a metatag field associated with the captured image.

According to another embodiment of the invention, a portable electronic device, comprising: a sound recording unit for recording sounds in the vicinity of the portable electronic device; an image capturing device for capturing an image; a processor for retrieving an audio record of recorded sounds from a first predetermined period of time prior to the capture of the image until a second predetermined period of time after the capture of the image; a word recognition system for processing the retrieved audio record to create a list of recognizable words in the retrieved audio record; and a memory for storing said list of recognizable words in a metatag field associated with the captured image.

According to another embodiment of the invention, a portable electronic device, comprising: an image capturing device for capturing an image; a sound recording unit for recording sounds in the vicinity of the portable electronic device for a predetermined period of time after the image is captured; a word recognition system for processing the recorded sounds to create a list of recognizable words in a the recorded sounds; and a memory for storing the list of recognizable words in a metatag field associated with the captured image.

Further embodiments of the invention are defined in the dependent claims.

It is an advantage of embodiments of the invention that the descriptive metatags are created automatically from the sounds recorded in the vicinity of the portable electronic device.

### BRIEF DESCRIPTION OF THE DRAWINGS

Further objects, features and advantages of embodiments of the invention will appear from the following detailed description of the invention, reference being made to the accompanying drawings, in which:

FIG. 1 illustrates a portable electronic device as a mobile phone for use by the invention;

FIG. 2 illustrates a block diagram of different units provided in the mobile phone of FIG. 1 according to one embodiment of the invention;

FIG. 3 is a flow chart describing the operation of the portable electronic device according to one embodiment of the invention; and

FIG. 4 is a flow chart describing the operation of the portable electronic device according to one embodiment of the invention.

### DETAILED DESCRIPTION OF EMBODIMENTS

Specific illustrative embodiments of the invention will now be described with reference to the accompanying drawings. This invention may, however, be embodied in many different forms and should not be construed as limited to the embodiments set forth herein. Rather, the disclosed embodiments are provided so that this specification will be thorough and complete, and will fully convey the scope of the invention to those skilled in the art. The terminology used in the detailed description of the particular embodiments illustrated in the accompanying drawings is not intended to be limiting of the invention. Furthermore, in the drawings like numbers refer to like elements.

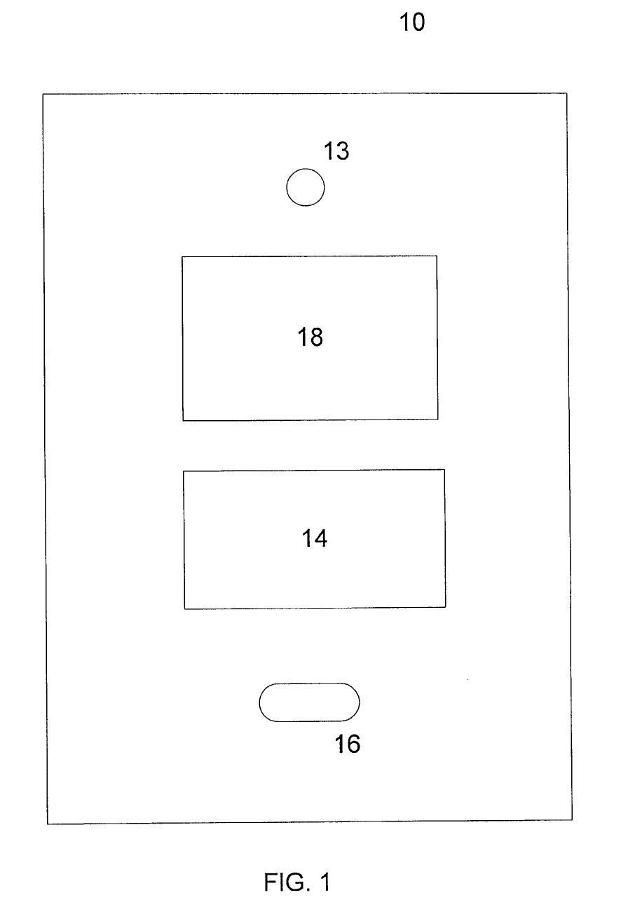

In FIG. 1 there is shown a front view of a portable electronic device in the form of a portable communication device, and particularly in the form of a mobile phone 10. The mobile phone 10 includes image handling functionality, which will be described in more detail later. The mobile phone 10 may include a display 12 and a set of tacile user input units, for example, in the form of a number of keys on a keypad 14, via which a user may control the image management functionality. The mobile phone 10 may include a microphone 16 that may receive sound from a user of the mobile phone 10. The mobile phone 10 also comprises a camera 13 which is capable of recording various images such as pictures and videos. A mobile phone is just one example of a portable electronic device according to the present invention. The invention is in no may limited to this type of device, but can be applied on other types of portable communication devices, for instance a smartphone and a communicator or other portable electronic devices like a lap top computer, a palm top computer, electronic organizer or image viewer, or other type of handheld device.

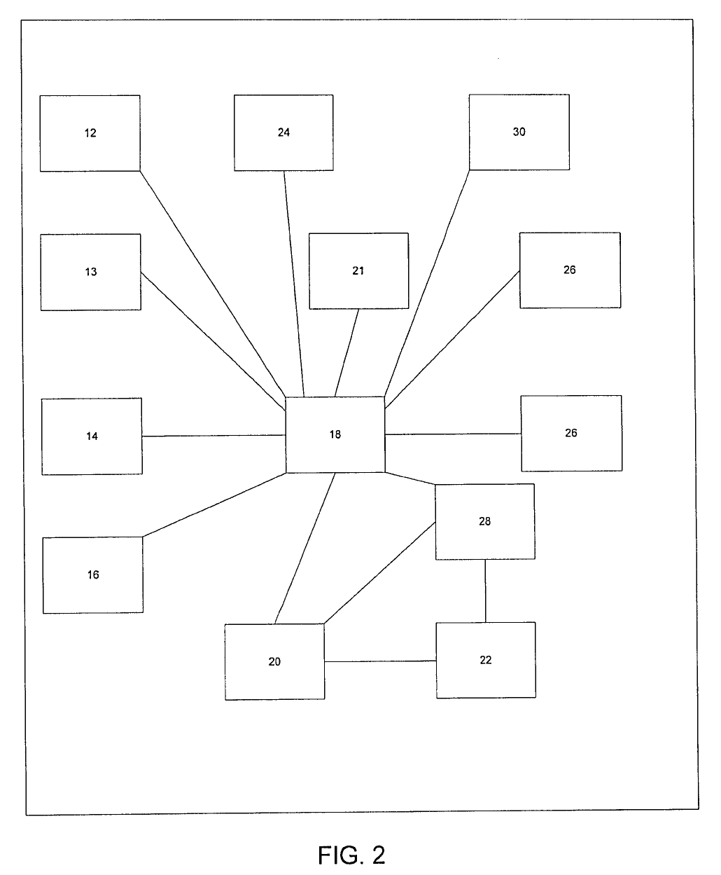

FIG. 2 shows a functional diagram as a block schematic of modules or units in the mobile phone 10. The mobile phone 10 may include the display 12, the camera 13, the keypad 14, and the microphone 16, where microphone 16 may be connected to a sound recording unit 20. The sound recording unit 20 may, in turn, be connected to a processor 21, a sound file store 22 and to a voice recognition unit 28, which voice recognition unit 28 may also be connected to the sound file store 22. The voice recognition unit 28 may be a typical type of voice recognition unit that is normally used in phones in relation to dialing phone numbers. An image handling application may be provided by a digital image handling unit 18, which may be connected to the display 12, the camera 13, the keypad 14, the sound recording unit 20, the sound file store 22, the voice recognition unit 28, the sound file store 22 and/or image store 24. The digital image handling unit 18 may also be connected to an association table 26, as well as to a communication unit 30, which communication unit 30 can be an interface for connection to a computer like a PC, for instance, in the form of a USB port.

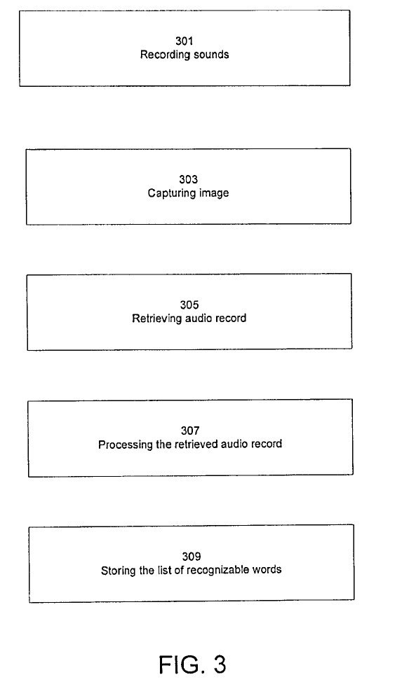

One embodiment of the invention will now be described with reference to FIG. 3. According to one embodiment of the invention, the sound recording unit 20 continuously records sound in the vicinity of the mobile phone 10 through the microphone 16 when the mobile phone 10 is powered on in step 301. In the alternative, the sound recording unit 20 may begin recording when the camera 13 is activated. In either case, the sound recording unit 20 is recording sounds in the vicinity of the mobile phone 10 prior to the user taking a picture or recording a video. Once an image is captured by the camera 13 in step 303, the processor 21 retrieves the audio record recorded by the sound recording unit from a first predetermined period of time prior or the capture of the image until a second predetermined period of time after the capture of the image. For example, the processor 21 may retrieve a 60 second sound clip beginning 30 seconds before the image is captured and continue for 30 seconds after the image has been captured in step 305.

The voice recognition unit 28 then processes the retrieved audio record to determine if any of the recorded sounds are recognizable words in step 307. In other words, the voice recognition unit 28 determines if the user (or some other person) spoke either before or after the image was captured which describe the picture. Since the user will know that this feature is being used, the user will know to speak words which will describe the image being captured.

The recognizable words are then put in a list. According to one embodiment of the invention, the list of recognizable words are then created into metatags for the captured image and stored with the captured image in step 309. In the alternative, the processor 21 can display the list of recognizable words on the display 12. The user can then select which of the words should be used as metatags using the keypad 14.

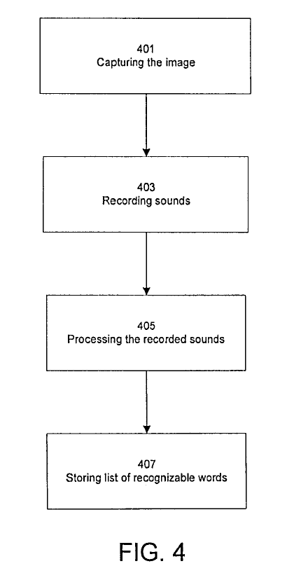

Another embodiment of the invention will now be described with reference to FIG. 4. In step 401, an image is captured by the camera 13. In response to the capture of the image, the sound recording unit 20 begins recording sounds in the vicinity of the mobile phone 10 for a predetermined period of time, e.g., 15 seconds, 30 seconds, etc., in step 403. After the predetermined period of time expires, the sound recording unit 20 stops recording. In step 405, the voice recognition unit 28 then processes the recorded sounds to determine if any of the recorded sounds are recognizable words. In other words, the voice recognition unit 28 determines if the user (or some other person) spoke after the image was captured which describe the picture. Since the user will know that this feature is being used, the user will know to speak words which will describe the image which was captured.

The recognizable words are then put in a list. According to one embodiment of the invention, the list of recognizable words are then created into metatags for the captured image and stored with the captured image in step 407. In the alternative, the processor 21 can display the list of recognizable words on the display 12. The user can then select which of the words should be used as metatags using the keypad 14.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. It should be appreciated that the different features and steps of the invention may be combined in other combinations than those described. The scope of the invention is only limited by the appended patent claims.

What is claimed is:

1. A method for labeling an image recorded by a portable device with descriptive tags, comprising the steps of:
recording sounds in the vicinity of the portable device;
capturing the image;
retrieving audio record of recorded sounds from a first predetermined period of time prior to the capture of the image until a second predetermined period of time after the capture of the image;
processing the retrieved audio record to create a list of recognizable words in the retrieved audio record;
storing said list of recognizable words in a metatag field associated with the captured image.

2. The method according to claim 1, wherein the image is a picture or a video.

3. The method according to claim 1, wherein the portable device begins recording sounds when the portable device is turned on.

4. The method according to claim 1, wherein the portable device begins recording sounds when an image capturing device in the portable device is turned on.

5. The method according to claim 1, further comprising the steps of:
displaying the list of recognizable words on a screen;
storing words selected by a user in the metatag field associated with the captured image.

6. A method for labeling an image recorded by a portable device, comprising the steps of:
capturing the image;
recording sounds in the vicinity of the portable device for a predetermined period of time after the image is captured;
processing the recorded sounds to create a list of recognizable words in the recorded sounds;
storing said list of recognizable words in a metatag field associated with the captured image.

7. The method according to claim 6, wherein the image is a picture or a video.

8. The method according to claim 6, further comprising the steps of:
displaying the list of recognizable words on a screen;
storing words selected by a user in the metatag field associated with the captured image.

9. A portable electronic device, comprising:
a sound recording unit for recording sounds in the vicinity of the portable electronic device;
an image capturing device for capturing an image;
a processor for retrieving an audio record of recorded sounds from a first predetermined period of time prior to the capture of the image until a second predetermined period of time after the capture of the image;
a word recognition system for processing the retrieved audio record to create a list of recognizable words in the retrieved audio record;
a memory for storing said list of recognizable words in a metatag field associated with the captured image.

10. The portable electronic device according to claim 9, wherein the image is a picture or a video.

11. The portable electronic device according to claim 9, wherein the sound recording unit begins recording sounds when the portable electronic device is turned on.

12. The portable electronic device according to claim 9, wherein the sound recording unit begins recording sounds when the image capturing device is turned on.

13. The portable electronic device according to claim 9, further comprising:
a display for displaying the list of recognizable words;
a tactile user input unit for allowing a user to select which of the words in the list are stored in the metatag field associated with the captured image.

14. A portable electronic device, comprising:
an image capturing device for capturing an image;
a sound recording unit for recording sounds in the vicinity of the portable electronic device for a predetermined period of time after the image is captured;
a word recognition system for processing the recorded sounds to create a list of recognizable words in a the recorded sounds;
a memory for storing the list of recognizable words in a metatag field associated with the captured image.

15. The portable electronic device according to claim 14, wherein the image is a picture or a video.

16. The portable electronic device according to claim 14, further comprising:
a display for displaying the list of recognizable words;
a tactile user input for allowing a user to select which of the words in the list are stored in the metatag field associated with the captured image.
